(19) United States
(12) Patent Application Publication
(10) Pub. No.: US 2011/0257804 A1
(43) Pub. Date: Oct. 20, 2011

(54) Administration of Power Environments

(75) Inventors: Ripal S. Goel, Plano, TX (US); Robert E. Gerard, Fort Wayne, IN (US)

(73) Assignee: Raytheon Company, Waltham, MA (US)

(21) Appl. No.: 13/087,139

(22) Filed: Apr. 14, 2011

Related U.S. Application Data
(60) Provisional application No. 61/324,189, filed on Apr. 14, 2010.
(60) Provisional application No. 61/324,206, filed on Apr. 14, 2010.

(51) Int. Cl. G06F 1/32; G06F 1/28

(52) U.S. Cl. 700/291; 700/297; 700/295

(57) ABSTRACT

In certain embodiments, a power administration system includes a memory module storing power management data for managing elements of a first power environment. The elements include a power system, one or more sensors, and one or more power consumers. One or more processing modules collect operational data for elements of the first power environment and translate the operational data from a first format to a first abstracted format associated with an abstraction layer for interacting with heterogeneous power environments. The processing modules collect external data from external information sources, including an environmental source providing environmental data, and translate the external data from a second format associated with a corresponding external information source to a second abstracted format associated with the abstraction layer. The processing modules update the power management data according to the translated operational data in the first abstracted format and the translated external data in the second abstracted format.

### RELATED APPLICATIONS

This application claims the benefit under 35 U.S.C. §119(e) of the priority of U.S. Provisional Application Ser. No. 61/324,189, filed Apr. 14, 2010, entitled “Power Grid Administration System” and U.S. Provisional Application Ser. No. 61/324,206, filed Apr. 14, 2010, entitled “Power Generation Modeling System.”

### BACKGROUND

Electrical power used by consumers, such as residential users, commercial users, government users, and industrial users, are typically provided by an electrical power grid. The electrical power grid generally includes multiple power generation stations that generate electrical power, and an electrical transmission/distribution system that delivers the generated electrical power to consumers.

### SUMMARY

In certain embodiments, a power administration system includes a memory module storing power management data for managing elements of a first power environment. The elements include a power system, one or more sensors, and one or more power consumers. One or more processing modules collect operational data for elements of the first power environment and translate the operational data from a first format to a first abstracted format associated with an abstraction layer for interacting with heterogeneous power environments. The processing modules collect external data from external information sources, including an environmental source providing environmental data, and translate the external data from a second format associated with a corresponding external information source to a second abstracted format associated with the abstraction layer. The processing modules update the power management data according to the translated operational data in the first abstracted format and the translated external data in the second abstracted format.

Certain embodiments of the present disclosure may provide one or more technical advantages. For example, certain embodiments may provide enhanced visualization of one or more managed power environments through a graphical user interface (GUI). These visualizations may provide dynamic situational awareness of one or more managed power environments. As another example, certain embodiments may provide intelligent, autonomic management of one or more power environments. As another example, certain embodiments may provide a framework that is interoperable among a number of heterogeneous power environments and/or microgrids. As a particular example, certain embodiments may implement a service-oriented architecture or other abstraction layer that abstracts various operations across heterogeneous power environments. Certain embodiments combine supervisory control and data acquisition (SCADA) with an energy management system (EMS) to provide an intelligent and sometimes automated framework for managing power environments, and that provides a common operating picture of the managed power environment. As another example, certain embodiments support adjacent energy markets, such as both renewable and non-renewable energy markets.

Certain embodiment of a power administration system may provide enhanced robustness for power environments that may operate in hazardous regions, such as those in a military war zone. In many cases, power environments operating in a military war zone may be prone to attack either directly or remotely via cyber attack. Management computing system may receive substantially real-time operating status information from elements configured in a power environment and adjusts operation of the elements to mitigate outages (or other issues) that may be experienced by certain power environment elements that are prone to attack. A power management tool may provide an energy management and control (M&C) system for a microgrid that may be self-aware and/or self-healing.

Certain embodiments of the present disclosure may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

A more complete understanding of embodiments of the disclosure will be apparent from the detailed description taken in conjunction with the accompanying drawings in which:

FIG. 1 illustrates an example power management system for managing a power environment according to certain embodiments of the present disclosure;

FIG. 2 illustrates an example power environment management system 200 for managing multiple microgrids, according to certain embodiments of the present disclosure; and

FIG. 3 illustrates an example method for managing a power environment according to certain embodiments of the present disclosure.

### DESCRIPTION OF EXAMPLE EMBODIMENTS

Electrical power is typically provided by an electrical power system that administers the generation of electrical power and how this power is delivered to consumers. The power system may include electrical power generation stations that generate electrical power using differing forms of energy. Examples of energy sources used by electrical power generation stations may include, but are not limited to, renewable and non-renewable energy sources. Particular examples may include hydro-dynamic power that harnesses the energy of moving water, solar power that harnesses solar radiant energy, wind power, and/or natural gas, coal, or other fossil fuel energy sources.

Each of these power generation systems may have characteristics that make their use advantageous in certain scenarios. For example, power generation systems that use renewable energy, such as wind energy, or solar energy may be desired based upon their ecologically friendly use of resources; however, these sources of energy may be prohibitive based upon certain environmental conditions, such as on non-windy or cloudy days. Providing a computing framework capable of managing these often disparate types of power systems in an intelligent manner would be beneficial.

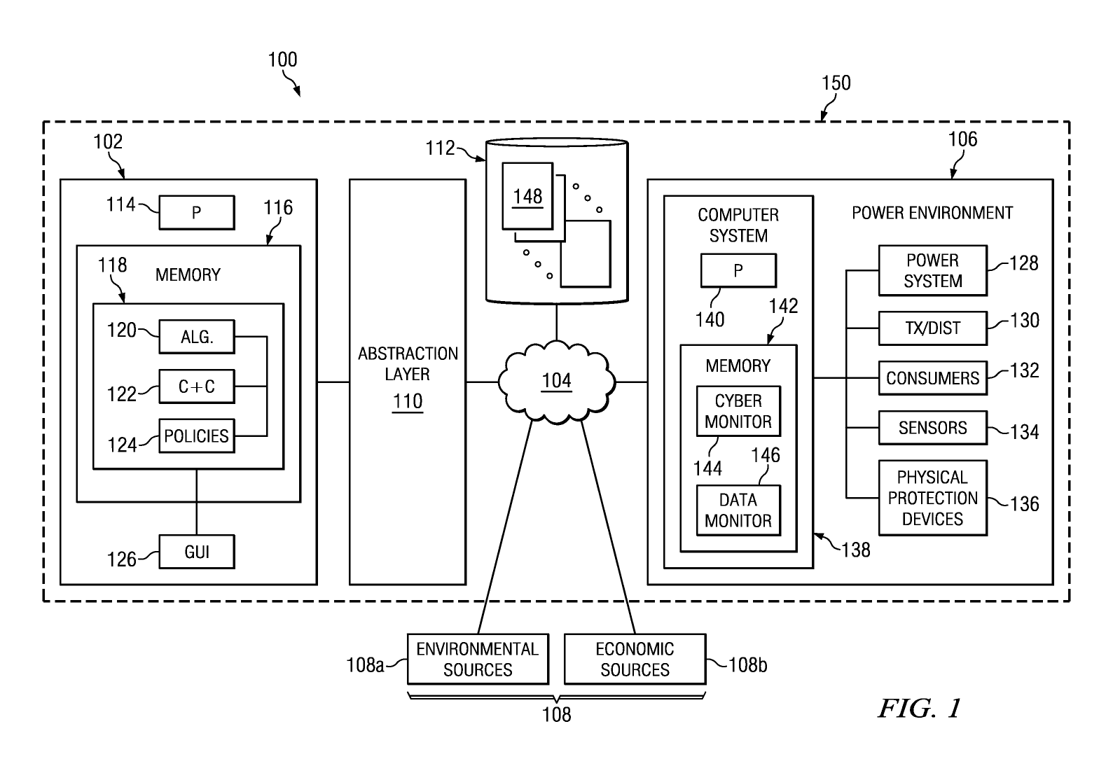

FIG. 1 illustrates an example power management system 100 for managing a power environment according to certain embodiments of the present disclosure. In the illustrated example, system 100 includes in part a management computing system 102, a network 104, a power environment 106, one or more external information sources 108, an abstraction layer 110, and a storage module 112. Although system 100 is described as including particular components, the present disclosure contemplates system 100 including any suitable components, according to particular needs.

Management computing system 102 may be implemented using any suitable type of processing system and may include any suitable combination of hardware, firmware, and software. For example, management computing system 102 may include one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, personal data assistant (PDA), one or more Internet Protocol (IP) telephones, smart phones, table computers, one or more servers, a server pool, one or more processors within these or other devices, or any other suitable processing device. Management computing system 102 may be a stand-alone computer or may be a part of a larger network of computers associated with an entity.

Management computing system 102 may include processing unit 114 and memory unit 116. Processing unit 114 may include one or more microprocessors, controllers, or any other suitable computing devices or resources. Processing unit 114 may work, either alone or with other components of system 100, to provide a portion or all of the functionality of system 100 described herein. Memory unit 116 may take the form of any suitable combination of volatile and non-volatile memory including, without limitation, magnetic media, optical media, RAM, ROM, removable media, and any other suitable memory component.

Management computing system 102 may be operable to facilitate management of power environment 106. For purposes of this description, management of power environment 106 may include operations such as viewing information about power environment 106, monitoring power environment 106, and controlling power environment 106. Management computing system 102 may be operable to perform some or all of these management operations automatically, substantially without or completely without human intervention. Additionally or alternatively, a human user may interact with management computing system 102 to direct the management of power environment 106.

Management computing system 102 may include a power management tool 118. For example, memory unit 116 of management computing system 102 may store a power management tool 118. Power management tool 118 may be implemented using any suitable combination of hardware, firmware, and software.

In general, power management tool 118 facilitates management of power environment 106 based on collected power management data. The collected power management data may include any suitable combination of operational data regarding elements of power environment 106, external data collected from one or more external information sources 108 (described below), and any other suitable data. In certain embodiments, a portion or all of power management tool 118 may be implemented as a service in a service-oriented architecture (SOA).

In the illustrated example, power management tool 118 includes one or more algorithms 120, a command and control module 122, and one or more policies 124. Power management tool may analyze the collected power management data using algorithms 120. Algorithms 120 may serve any suitable purpose. As just a few examples, algorithms may specify when and how graphical user interface (GUI) 126 (described below) should be updated, when to issue one or more commands to power environment 106 and the nature of the issued command, when and how to issue alert, and other suitable purposes. Algorithms may consult or otherwise interact with policies 124 to determine appropriate actions to perform in response to an analysis of collected power management data. Policies 124 may specify the frequency with which power management tool 118 analyzes collected power management data.

Command and control module 122 may provide a set of commands that may be issued to power environment 106, as well as functionality for issuing such commands. In certain embodiments, these commands include commands to adjust a status of one or more elements of power environment 106, turn on one or more elements of power environment 106, turn off one or more elements of power environment 106, and to perform other suitable actions.

Management computing system 102 may include a GUI 126, which may be generated by power management tool 118. As will be described in greater detail below, GUI 126 may display visualizations that may be useful for managing power environment 106. For example, these visualizations may provide a view of power environment 106, including potential some or all of the elements of power environment 106. As another example, these visualizations may provide a view (e.g., to a user of management computing system 102) of past, current, and/or potential future operational status of power environment 106. As another example, while certain functions provided by power management tool 118 may be automated (in some cases requiring little or no human intervention), in certain embodiments a user may manually intervene using GUI 126 to issue commands or otherwise reconfigure portions of system 100.

Components of system 100 may be communicatively coupled via a network 104. Network 104 facilitates wireless or wireline communication, and may communicate, for example, IP packets, Frame Relay frames, Asynchronous Transfer Mode (ATM) cells, voice, video, data, and other suitable information between network addresses. Network 104 may include one or more local area networks (LANs), radio access networks (RANs), metropolitan area networks (MANs), wide area networks (WANs), mobile networks (e.g., using WiMax (802.16), WiFi (802.11), 3G, 4G, or any other suitable wireless technologies in any suitable combination), all or a portion of the global computer network known as the Internet, and/or any other communication system or systems at one or more locations, any of which may be any suitable combination of wireless and wireline.

Power environment 106 may be an environment of elements that, among other things, is operable to generate and provide electrical power to consumers. Generally, power environment 106 and its constituent elements are the components being managed by management computing system 102. Power environment 106 may include any suitable combination of hardware, firmware, and software.

In the illustrated example, power environment 106 includes a number of elements. For example, power environment 106 includes a power system 128, one or more transmission/distribution devices 130, one or more consumers 132, one or more sensors 134, one or more physical protection devices 136, and one or more computer systems 138. Although power environment 106 is illustrated and described as including particular elements, the present disclosure contemplates power environment 106 comprising any suitable elements according to particular needs.

Power system 128 may include systems for, among other things, electricity generation, energy storage, and loads. Power system 128 may include any suitable combination of energy sources, such as renewable energy sources, non-renewable energy sources, alternate energy sources, a power utility grid, and any other suitable types of energy sources (some of which may overlap). Particular example energy sources for power system 128 may include fuel cells, wind, solar, hydroelectric, geothermal, biomass, biofuel, and any other suitable types of energy sources.

Transmission/distribution devices 130 provide the electrical power generated by power system 128 to consumers 132. Transmission/distribution devices 130 may include any suitable devices for facilitating the delivery of generated electrical power to consumers 132. For example, transmission/distribution devices 130 may include elements, such as transmission lines and/or one or more switch points that selectively interconnect power system 128 with consumers 132 that use electrical energy generated and/or stored by power system 128.

Consumers 132 may include any suitable consumers of the electrical power generated by power system 128. Reference to consumers may include any suitable combination of human consumers and devices/facilities that consume power. Consumers 132 may include any suitable combination of residential consumers, commercial consumers, government consumers, industrial consumers, and other types of consumers of electrical power.

Sensors 134 may include any suitable types of sensors, according to particular needs. In general, sensors 134 may monitor one or more conditions associated with power environment 106, such as by detecting occurrence of one or more events, detecting the presence of one or more conditions, and/or monitoring one or more conditions. Sensors 134 may be configured to report on a state or measurement (e.g., either proactively on a suitable schedule or according to a detected condition, or in response to being polled). Certain types of sensors 134 may be referred to as switches that are operable to initiate one or more actions or to detect a change in state. Example sensors may include any suitable combination of environmental sensors (e.g., temperature sensors, barometric pressure sensors, humidity sensors, water or other chemical sensors, wind speed, radiation sensors pressure difference sensors, and any other suitable types of environmental sensors), sensors for detecting operating conditions associated with power system 128, on/off switches, door open/close switches, check-in/check-out sensors, switches, motion sensors, fluid level sensors, infrared sensors, and any other suitable types of sensors.

Sensors 134 may be local to or remote from power environment 106. Some or all of sensors 134 may be located in or around the one or more premises that house power environment 106. Sensors 134 may communicate with computer system 138 in any suitable manner.

Physical protection devices 136 may include devices that protect, monitor, secure power environment 106 and its constituent elements. For example, physical protection devices 136 may include locks, access card scanners, security cameras, and other types of devices that physically protect power environment 106 and its constituent elements. Physical protection devices 136 may be programmed (possibly in combination with computer system 138) to generate alarms or other types of alerts upon the occurrence of certain events. Additionally or alternatively, physical protection devices 136 may log information associated with their operation.

Computer system 138 may be implemented using any suitable type of processing system and may include any suitable combination of hardware, firmware, and software. For example, computer system 138 may include one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, PDA, one or more IP telephones, smart phones, table computers, one or more servers, a server pool, one or more processors within these or other devices, or any other suitable processing device. Computer system 138 may be a stand-alone computer or may be a part of a larger network of computers associated with an entity.

Computer system 138 may include processing unit 140 and memory unit 142. Processing unit 140 may include one or more microprocessors, controllers, or any other suitable computing devices or resources. Processing unit 140 may work, either alone or with other components of system 100, to provide a portion or all of the functionality of system 100 described herein. Memory unit 142 may take the form of any suitable combination of volatile and non-volatile memory including, without limitation, magnetic media, optical media, RAM, ROM, removable media, and any other suitable memory component.

Computer system 138 may include a cyber monitoring module 144. Cyber monitoring module 144 may be implemented using any suitable combination of hardware, firmware, and software. Cyber monitoring module 144 may be operable to monitor computer system 138 and other elements of power environment 106 for possible cyber attacks or other security issues, to detect cyber security vulnerabilities, and to perform other suitable security monitoring, detection, and analysis. Cyber monitoring module 144 may be programmed to generate alarms or other types of alerts upon the occurrence of certain events. Additionally or alternatively, cyber monitoring module 144 may log information associated with its operation, such as the occurrence and result of any scans, the detection of events, and other suitable information.

Computer system 138 may include a data monitor 146, which may be implemented using any suitable combination of hardware, firmware, and software. Data monitor 146 may be operable to monitor other elements of power environment 106 for operating data and to handle communications with management computing system 104. In certain embodiments, data monitor 146 is able to communicate with various elements of power environment 106 in a format understandable to those particular elements.

System 100 may include one or more external information sources 108 that may provide data useable by management computing system 102 to perform its associated management functions. External information sources 108 may provide information external to managed power environment 106 that may be useful in evaluating past, present, and future conditions associated with managing power environment 106. In certain embodiments, external information sources 108 include one or more of environmental sources 108a and economic sources 108b, though the present disclosure contemplates system 100 including any suitable number and types of external information sources 108.

External environmental sources 108a may include web sites, web services, and/or other suitable sources of information regarding environmental conditions. These environmental conditions may include, for example, past, present, and/or future weather conditions. Other example environmental conditions may include past, present, and/or future natural disaster conditions (which, if appropriate, may overlap weather conditions). A particular example external environmental source 108a may include a database, web site, and/or web service provided by the United States National Oceanic and Atmospheric Administration (NOAA).

External economic sources 108b may include web sites, web services, and/or other suitable sources of information regarding economic conditions. These economic conditions may include, for example, past, present, and/or future economic conditions. Particular example economic information may include feed-in-tariffs (FiT). A feed-in-tariff may include a policy mechanism for encouraging the adoption of renewable energy sources and/or for facilitating the acceleration a move toward “grid parity.” In certain situations, FiTs include one or more of the following provisions: (1) guaranteed grid access; (2) long-term contracts for the electricity produced; and (3) purchase prices that are based on the cost of renewable energy generation and encourage toward grid parity. A particular example external economic source 108b may include a database, web site, and/or web service adapted to provide FiT information.

Different types of power environments 106 may be implemented in different ways using different elements. For example, a first power environment 106 may be implemented using a first combination of hardware components while a second power environment 106 may be implemented using a different second combination of hardware. As a more particular example, a first power environment 106 may be implemented using a power system 128 that uses a non-renewable energy source while a second power environment may use a power system 128 that uses a renewable energy source. Even within these two types of power sources (i.e., non-renewable and renewable), the particular types of energy sources may use different hardware (and possibly other elements) to implement power environment 106.

In other words, different power environments 106 may be heterogeneous. In certain embodiments, the term “heterogeneous” means that different power environments 106 may be associated with different power sources and/or include different combinations of hardware, firmware, and software, possibly provided by different vendors. Each power environment 106 may be associated with its own management operations and format for implementing those management operations. For example, issuing commands to elements of a first power environment 106 may be implemented in a different way than issuing similar commands to elements of a second power environment 106. However, many operations and other management functions may be common (though implemented differently), across different power environments 106. Additionally, different power environments 106 may have varying scales or may be scalable such that the size of the power environment 106 may change over time.

It may be desirable to provide a framework for managing heterogeneous types of power environments 106 using an abstracted, common set of operations. This may facilitate a more flexible, dynamic, and automated system for managing various types of power environments 106. Each power environment 106 and its associated elements may describe power management in different ways. For example, each element may have different descriptions, different interfaces (e.g., APIs), different inputs, different outputs, and different methods to communicate. However, these multiple elements may provide a substantially similar set of functionality and data elements for power management. As will be described in more detail below, these similarities may be leveraged to abstract from the environment-specific solutions to provide a substantially uniform way of interacting with power environments 106 of different types.

In addition to heterogeneous power environments 106, different types of external information sources 108 may present their associated information in different ways. For example, a first external information source 108 may be a web service that presents information according to a specified interface specification, while a second external information source 108 may be a SQL database that is queried using SQL queries.

Embodiments of the present disclosure provide an abstraction layer 110 for managing heterogeneous power environments 106 and for interacting with heterogeneous of external information sources 108. Abstraction layer 110 may provide an abstracted set of operations for managing heterogeneous types of power environments 106. Abstraction layer 110 may provide abstracted methods for messaging, collecting and storing data values, issuing commands, and other suitable functions across heterogeneous power environments 106. Abstraction layer 110 may be implemented using any suitable combination of hardware, firmware, and software.

One example technique for implementing abstraction layer 110 and its associated abstracted functionality is using a SOA. For example, abstraction layer 110 may be implemented using a SOA bus and one or more SOA interfaces (e.g., a SOA interface associated with management computing system 102 for interacting with the SOA bus, and a SOA interface associated with computer system 138 for interacting with the SOA bus).

In certain embodiments, abstraction layer 110 may allow management computing system 102 reduce or eliminate the coupling of management computing system 102 to the particular elements (e.g., energy sources and the hardware, firmware, and software) of a particular power environment 106, or to a particular scale of power environment 106. Instead, certain embodiments provide an abstracted layer of interaction functions that may be used across heterogeneous power environments 106. Example abstracted messages that may be implemented by abstraction layer 110 may include commands, request for collection of power management data (e.g., status requests and requests for operational parameters), responses to requests for collection of power management data (e.g., the provision of power management data), warnings or other alerts, and any other suitable information.

Although illustrated primarily as a distinct component of system 100, the present disclosure contemplates implementing abstraction layer 110 in any suitable manner. For example, portions or all of abstraction layer 110 may be implemented using any suitable combination of management computing system 102 (e.g., using power management tool 116), computer system 138 (e.g., data monitor 146) of power environment 106, external information sources 108, and a computer system implementing abstraction layer 110.

In certain embodiments, management computing system 102 may implement a portion of abstraction layer 110. For example, management computing system 102 may include a number of software adapters that are operable to translate data from a first format that is specific to a particular element of management computer system 102 and/or power environment 106 to an abstract format that can be used for messaging and data storage across different types of elements, and vice versa if appropriate. Additionally or alternatively, in certain embodiments, computer system 138 may implement a portion of abstraction layer 110. For example, computer system 138 may include a number of software adapters that are operable to translate data from a first format that is specific to a particular element of management computer system 102 and/or power environment 106 to an abstract format that can be used for messaging and data storage across different types of elements, and vice versa if appropriate. Any of these examples can be used in any suitable combination.

As a particular example, abstraction layer 110 is implemented using a combination of management computing system 102 and computer system 138 of power environment 106. In this example, management computing system 102 includes a number of software adapters that are operable to translate data from a format that is specific to a particular element of management computer system 102 (e.g., from a format associated with command and control module 122) to an abstract format that can be used for messaging and data storage across different types of elements. In this example, these adapters may also be able to translate data received from external information sources 108 from a format that is specific to a particular external information source 108 to an abstract format that can be used for representing common types of external data received from different external information sources (e.g., weather data). In this example, computer system 138 includes a number of software adapters that are operable to translate data both from a format that is specific to a particular element of power environment 106 to an abstract format that can be used for messaging and data storage across different types of elements, as well as from the abstract format to a format that is specific to a particular element of power environment 106. Although this particular example has been described, the present disclosure contemplates implementing the features and operation of abstraction layer 110 in any suitable manner, according to particular needs.

While abstraction layer 110 has been illustrated as being implemented in a particular manner, the present disclosure contemplates implementing abstraction layer 110 in any suitable manner. Furthermore, although SOA is described as a technique for implementing abstraction layer 110, the present disclosure contemplates using any suitable technique for implementing abstraction layer 110.

In embodiments in which abstraction layer 110 is implemented using SOA, abstraction layer 110 may comprise a SOA bus. As just one example, a SOA bus may be implemented as an enterprise service bus (ESB). The ESB may represent software that lies between applications/devices associated with management computing system 102 and applications/devices associated with power environment 106/external information sources 108 and implements communication among those components. In certain embodiments, the ESB may replace direct communication among these components such that communication takes place using the ESB. To provide this capability, the ESB may encapsulate the functionality offered by its component applications in an abstracted manner, possibly using a message model. The message model may define an abstracted set of messages that the ESB may transmit/receive, which may be standard across different types of power environments 106/external information sources 108. The ESB may also handle routing messages to appropriate applications or other destinations. Since messages communicated among components of system 100 may be formatted in a manner that is not according to the standard message format implemented by the ESB, the ESB or some other suitable component of system 100 may translate the messages into the standard format. Components such as adapters may perform this translation.

In certain embodiments, each computer system 138 exposes a SOA-based interface that provides information to management computing system 102 (e.g., power management tool 118) and/or accept command (or other) messages from management computing system 102 (e.g., power management tool 118). An SOA may include services that each includes an executable segment of code that provides a specified function. In certain embodiments, the function provided by each service has a level of granularity sufficient for management of power environment 106 by management computing system 102 (e.g., power management tool 118). In certain embodiments, the services may be administered through an ESB. The ESB may orchestrate multiple services together to provide one or more business applications, which in this particular application, is a power generation administration tool 22 that may be used to manage power environment 106.

Certain embodiments incorporating an SOA may provide an advantage in that a control system may be implemented on existing elements of power environment 106 in a relatively efficient manner. For example, services implemented by the SOA interface may expose information about its associated power environment 106 in a relatively concise manner such sensitive information is not inadvertently leaked in an uncontrolled manner. Thus, managers of individual power environments 106 may be able to expose only those characteristics of their power environment 106 that does not include sensitive information. Additionally, the SOA interface may provide a relatively extensible system in which new and/or additional power environments 106 (or elements within a particular power environment 106) may be easily managed by the same or a different power management tool 118. In certain embodiments, the SOA or other abstraction layer 110 may also allow other commercial-off-the-shelf products to be plugged into system 100 with relative ease, whether from the management computing system 102 perspective, the power environment 104 perspective, and/or the external information sources 108 perspective.

System 100 may include storage module 112. Storage module 112 may take the form of any suitable combination of volatile or non-volatile memory including, without limitation, magnetic media, optical media, RAM, ROM, removable media, or any other suitable memory component. In certain embodiments, a portion of all of storage module 112 may include a database, such as one or more SQL servers or relational databases. Storage module 112 may be a part of or distinct from memory unit 116 of management computing system 102. The present disclosure contemplates storage module 112 being divided into any suitable number and types of storage modules.

Storage module 112 may store a variety of data that may be used by management computing system 102 (e.g., power management tool 118) to manage power environment 106. Although storage module 112 is described as including particular information in particular formats, storage module 112 may store any other suitable information and may store information in any suitable format. Furthermore, although particular information is described as being stored in storage module 112, the present disclosure contemplates storing this information in any suitable location, according to particular needs.

Storage module 112 may store data collected from power environment 106 and from external information sources 108 as well as data generated by power management tool 118, which collectively may be referred to as power management data 148. Power management data 148 may be used by management computing system 102 (e.g., power management tool 118) for use in managing power environment 106. For example, power management data 148 may include operational data related to the operation of elements of power environment 106. As another example, power management data 148 may include environmental data. Environmental data may be provided by sensors located at the power environment (e.g., temperature sensors, barometric pressure sensors, radiation sensors, or any other suitable types of sensors for detecting environmental conditions). Additionally, environmental data may be provided by external environmental sources 108a. As another example, power management data 148 may include economic data from economic sources 108b. The economic data may include, for example, data regarding FiTs. The stored power management data 148 may include any suitable combination of past, present, and forecasted data. In the case of forecasted data, such data may be generated or otherwise determined by management computing system 102.

Storage module 112 may store power management data 148 in any suitable manner, according to particular needs. In certain embodiments, storage module 112 stores a number of software objects, which may store appropriate power management data 148. Each object may represent one or more elements of power environment 106 and/or external information sources 108, or other suitable entities for which data may be stored. The objects may be organized according to any suitable class hierarchy or other suitable arrangement. Power management data 148 may be stored in software objects representing various elements of power environment 106 and or other suitable elements of system 100 that correspond to the element corresponding to the power management data 148.

In certain embodiments, the collection of one or more elements of system 100 forms what may be referred to as a microgrid 150. In the illustrated example, power management system 102, a portion or all of network 104, power environment 106, abstraction layer 110, and storage module 112 form microgrid 150. It should be understood that this particular collection of elements is provided for example purposes only. Microgrid 150 may include other suitable combinations of elements of system 100, as well as elements not illustrated. Additionally, a microgrid is just one example of an entity that may be formed by these elements.

Portions of system 100 may include logic contained within a computer-readable medium. Logic may include hardware, software, and/or other logic. The medium in which the logic is encoded may include a tangible medium. The logic may perform operations when executed by a processor (e.g., processing unit 114 and/or processing unit 140). Certain logic may include a computer program, software, computer executable instructions, and/or instructions capable being executed by a processor (e.g., processing unit 114 and/or processing unit 140). The logic may also be embedded within any other suitable medium without departing from the scope of the disclosure.

For example, power management tool 118, abstraction layer 110, cyber monitor 144, and data monitor 146, as well as other suitable components of system 100, may include executable code stored in a memory module and executed by a processor (e.g., of a computer system). The executable code may be implemented using any suitable programming language or platform and may communicate with computing platforms in any suitable manner. In certain embodiments, management computing system 102 and computer system 138 execute multiple services operating in a SOA for communicating information between one another.

In operation of an example embodiment of system 100, power management tool 118 is operable to administer the operation of power environment 106 based on power management data 148 received from power environment 106 and/or external information sources 108. For example, power management tool 118 may analyze power management data 148 according to one or more algorithms 120 and policies 124, and may determine whether to perform one or more actions based on the analysis and if so, what one or more actions to perform. Power management tool 118 may be able to perform some or all of these actions substantially autonomously, without requiring the input of a human user, thereby providing smart, autonomous management of heterogeneous types of power environments 106. As described above, the power management data received from power environment 106 (e.g., operational data) and external information sources 108 (e.g., environmental data and/or economic data) may be translated from a format associated with their native elements into an abstract format implemented using abstraction layer 110.

Certain embodiments of the present disclosure may provide one or more technical advantages. For example, certain embodiments may provide enhanced visualization of one or more managed power environments through a GUI 126. These visualizations may provide dynamic situational awareness of one or more managed power environments 106. As another example, certain embodiments may provide intelligent, autonomic management of one or more power environments 106. As another example, certain embodiments may provide a framework that is interoperable among a number of heterogeneous power environments 106 and/or microgrids 150. As a particular example, certain embodiments may implement a SOA or other abstraction layer 110 that abstracts various operations across heterogeneous power environments 106. Certain embodiments combine supervisory control and data acquisition (SCADA) with an energy management system (EMS) to provide an intelligent and sometimes automated framework for managing power environments 106, and that provides a common operating picture of the managed power environment 106. As another example, certain embodiments support adjacent energy markets, such as both renewable and non-renewable energy markets.

Certain embodiment of power administration system 100 may provide enhanced robustness for power environments 106 that may operate in hazardous regions, such as those in a military war zone. In many cases, power environments 106 operating in a military war zone may be prone to attack either directly or remotely via cyber attack. Management computing system 102 may receive substantially real-time operating status information from elements configured in a power environment 106 and adjusts operation of the elements to mitigate outages (or other issues) that may be experienced by certain power environment elements that are prone to attack. A power management tool 118 may provide an energy management and control (M&C) system for a microgrid 150 that may be self-aware and/or self-healing.

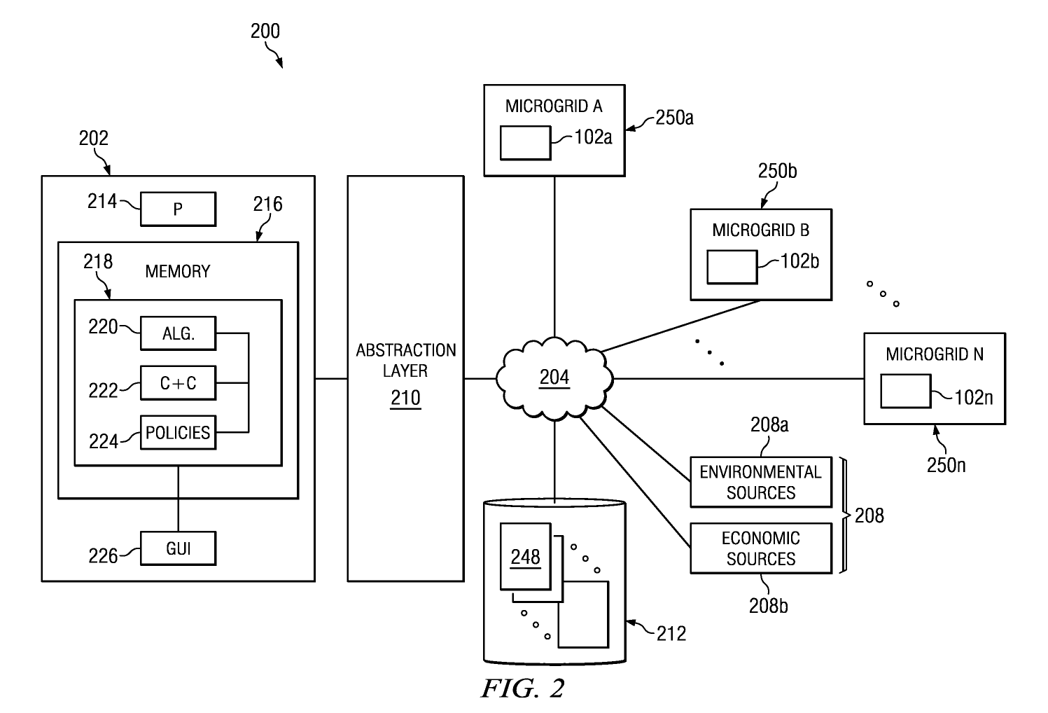

FIG. 2 illustrates an example power environment management system 200 for managing multiple microgrids, according to certain embodiments of the present disclosure. In the illustrated example, system 200 includes management computing system 202, network 204, microgrids 250, external information sources 208, abstraction layer 210, and storage module 212.

Management computing system 202 may be the same as and/or may share certain or all features in common with management computing system 102 of FIG. 1. Management computing system 202 may be used for managing multiple microgrids 250. It should be understood that in certain embodiments, even management computing system 102 of FIG. 1 may be capable of managing multiple microgrids 150 (or 250), if appropriate. The components of management computing system 202 (e.g., processing unit 214, memory unit 216, power management tool 218, algorithms 220, command and control module 222, policies 224, and GUI 226) may be the same as and/or share certain or all features in common with the components of management computing system 102 (e.g., processing unit 114, memory unit 116, power management tool 118, algorithms 120, command and control module 122, policies 124, and GUI 126) of FIG. 1.

Components of system 200 may be communicatively coupled via a network 206. Network 206 may be the same as and/or may share certain or all features in common with network 104 of FIG. 1. Network 206 facilitates wireless or wireline communication, and may communicate, for example, IP packets, Frame Relay frames, ATM cells, voice, video, data, and other suitable information between network addresses. Network 206 may include one or more LANs, RANs, MANs, WANs, mobile networks (e.g., using WiMax (802.16), WiFi (802.11), 3G, 4G, or any other suitable wireless technologies in any suitable combination), all or a portion of the global computer network known as the Internet, and/or any other communication system or systems at one or more locations, any of which may be any suitable combination of wireless and wireline. Portions or all of network 206 may be the same as or different from portions or all of network 104.

System 200 includes a number of microgrids 250. Each microgrid 250 may be the same as and/or may share certain or all features in common with microgrid 150 of FIG. 1. In certain embodiments, each microgrid 250 is associated with its own management computing system 102 (e.g., as illustrated in FIG. 1 where microgrid 150 is associated with management computing system 102). Microgrids 250 may or may not be heterogeneous. These management computing systems 102 may then report to a higher level management computing system 202. It should be noted that one of the management computing systems 102 of one of the microgrids 250 also may serve as this “higher level” management computing system 202, if appropriate. The microgrids 250 managed using management computing system 202 may be considered a cluster of microgrids 208. Although described as microgrids, the present disclosure contemplates management computing system 202 managing other suitable types of entities.

System 200 includes external information sources 208. External information sources 208 may be the same as and/or may share certain or all features in common with external information sources 108 of FIG. 1. In the illustrated example, system 200 includes external environmental sources 208a, which may provide environmental data. System 200 also includes external economic sources 208b, which may provide economic data.

System 200 includes abstraction layer 210. Abstraction layer 210 may be the same as and/or may share certain or all features in common with abstraction layer 110 of FIG. 1. As describe above with respect to abstraction layer 110, abstraction layer 210 may be implemented in a variety of ways. In certain embodiments, abstraction layer 210 implements a SOA that facilitates communication between management computing system 202 and the management computing systems 102 of heterogeneous microgrids 250. A portion or all of abstraction layer 210 may be implemented using management computing system 210 and management computing systems 110 of microgrids 250. The abstracted messaging format implemented by abstraction layer 210 may be the same as or different than the abstracted messaging format implemented by abstraction layers 110 of individual microgrids 250.

System 200 includes storage module 212. Storage module 212 may be the same as and/or may share certain or all features in common with storage module 212 of FIG. 1. Storage module 212 stores power management data 248 related to multiple microgrids 250.

In operation of an example embodiment of system 200, power management tool 218 is operable to administer the operation of microgrids 250 based on power management data 248 received from microgrids 250 and/or external information sources 208. For example, power management tool 218 may analyze power management data 248 according to one or more algorithms 220 and policies 224, and may determine whether to perform one or more actions based on the analysis and if so, what one or more actions to perform. Power management tool 218 may be able to perform some or all of these actions substantially autonomously, without requiring the input of a human user, thereby providing smart, autonomous management of heterogeneous types of microgrids 250. The power management data received from microgrids 250 (e.g., operational data) and external information sources 208 (e.g., environmental data and/or economic data) may be translated from a format associated with their native elements into an abstract format implemented using abstraction layer 210.

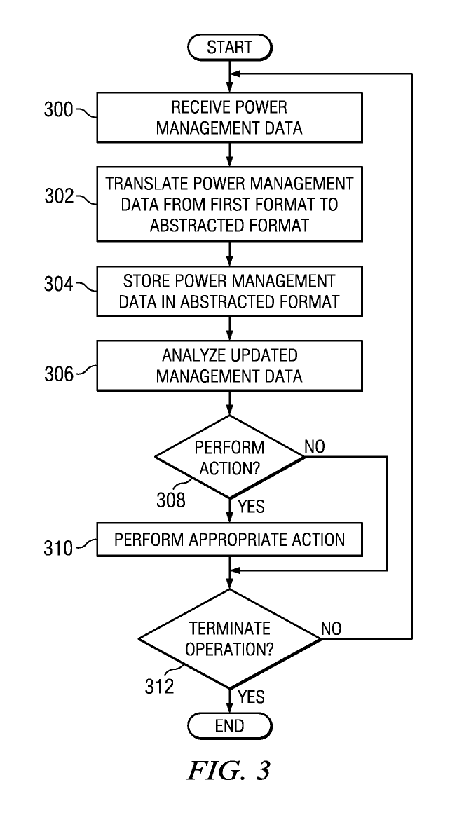

FIG. 3 illustrates an example method for managing a power environment according to certain embodiments of the present disclosure. This example method will be described with reference to FIG. 1. For purposes of this example, it will be assumed that both management computing system 102 and computer system 138 of power environment 138 implement abstraction layer 110.

At step 300, power management tool 118 may receive power management data. Power management data may be received in any suitable manner, according to particular needs. For example, power management tool 118 may poll computer system 138 for power management data. Computing system 138 may gather power operational or other data from elements of power environment 106 in any suitable manner. Additionally or alternatively, computer system 138 may communicate power management data to power management tool 118 on a scheduled or other basis.

At step 302, power management tool 118 may translate the collected power management data from a first format to a second, abstracted format. For example, the first format may be a format native to power environment 106 and/or the particular element or elements to which the power management data relates. As a particular example, power management tool 118 may translate operational data from a first format associated with power environment 106 to an abstracted format associated with abstraction layer 110. Additionally or alternatively, power management tool 118 may translate external data from a format associated with a corresponding external information source (e.g., the external information source from which the external data was received) to an abstracted format associated with abstraction layer 110.

In certain embodiments, rather than power management tool 118 translating the collected power management data from the first format to the second, abstracted format, computer system 138 may translate the power management data from the first format to the second, abstracted format prior to communicating the power management data to power management tool 118. For example, computer system 138 may include one or more adapters operable to perform this translation.

At step 304, management computing system 102 may store the power management data in the abstracted format in storage module 112. For example, power management tool 114 may store the translated power management data in storage module 112 as power management data 148. This power stored power management data may be an update to existing power management data or may be new power management data not previously stored in storage module 112. In certain embodiments, power management data 148 is stored in one or more objects of storage module 112.

At step 306, management computing system 102 may analyze a portion or all of power management data 148 stored in storage module 112. For example, power management tool 118 may analyze a portion or all of the updated power management data 148 using one or more algorithms 120 and according to one or more policies 124. Among other things, these algorithms 120 may specify when certain actions should be initiated by power management tool 118. As described above, these algorithms 120 may consider as inputs a variety of power management data 148, including operational data associated with power environment 106 and external data received from external information sources 108 (e.g., environmental data received from environmental sources 108a and economic data received from economic sources 108b).

At step 308, management computing system 102 (e.g., power management tool 118) may determine whether to perform an action in response to the analysis performed at step 306. In certain embodiments, step 308 may be a result of the analysis described above in step 306 such that the determination at step 308 is inherent in the analysis performed at step 306. Certain example actions are described below.

As a first example, management computing system 102 (e.g., power management tool 118) may determine whether to update GUI 126 based on the analysis of the updated power management data 148. This update may simply be to display more up-to-date status or other information related to the operation and/or configuration of power environment 106. In certain scenarios, this update may display one or more alerts based on the analysis of the updated power management data 148.

As a second example, management computing system 102 (e.g., power management tool 118) may determine whether to issue one or more alerts based on the analysis of the updated power management data 148. For example, issuing an alert may including causing a suitable component of management computing system 102 (e.g., power management tool 118) to communicate a message to one or more individuals or systems to notify the individuals or systems of an alert condition. The message may include any suitable any suitable combination of types of messages such as e-mails, text messages, telephone calls, and alarms. The message may include any suitable information, such as an indication of the alert condition and any suitable context information (e.g., operational conditions or environmental or economic conditions), according to particular needs. This alert could be communicated in response to detecting an emergency (or possible/impending emergency) situation or for any other suitable reason (e.g., according to policies 124).

As a third example, management computing system 102 (e.g., power management tool 118) may determine whether to issue one or more commands based on the analysis of the updated power management data 148. As described above, these commands may include a command to adjust a status of one or more elements of power environment 106, turn on one or more elements of power environment 106, turn off one or more elements of power environment 106, or to perform other suitable actions. In certain embodiments, these commands are communicated from power management tool 118 of management computing system 102 to computer system 138 of power environment 106.

Although the present disclosure contemplates commands being issued in any suitable manner, in certain embodiments, power management tool 118 determines that a command should be issued based on the analysis of the updated power management data 148. Power management tool 118 may interact with command and control module 122 to cause command and control module 122 to issue one or more commands, and in response to this interaction, command and control module 122 may issue the one or more commands.

Command and control module 122 may or may not communicate in the abstracted language of adaptation layer 104. In situations in which command and control module 122 does not communicate in the abstracted language of adaptation layer 104, adaptation layer 104 may translate commands or other messages communicated by command and control module 122 to the abstracted format implemented by adaptation layer 104. For example, one or more adapters associated with management computing system 102 may translate commands or other messages communicated by command and control module 122 to the abstracted format implemented by adaptation layer 104.

It may also be appropriate to translate the commands from the abstracted format to a format understandable to a target element of power environment 106. For example, the element of power environment 106 whose operational status the command is intended to affect may not understand the abstracted format in which the command is communicated. Thus, a suitable component (e.g., an adapter associated with adaptation layer 104 stored on computer system 138) may translate the command from the abstracted format to a format understandable to the target element of power environment 106. Computer system 138 or another suitable component of power environment 106 then may deliver the translated command to the target element.

If power management tool 118 determines at step 308 that, based on the analysis of power management data 148 at step 306, that an action should be performed, then at step 310 power management tool 118 may initiate performance of an appropriate action. As described above, example actions may include any suitable combination of updating GUI 126, issuing one or more alerts, issuing one or more commands, and performing any other suitable action(s).

At step 312, management computing system 102 may determine whether operation should be terminated. If management computing system 102 determines at step 310 that operation should be terminated, then method may end. If management computing system 102 determines at step 310 that operation should not be terminated, then the method may return to step 300 to await receipt of new data. Although returning to step 300 is described, the program and/or computer system performing this method (e.g., power management tool 118) may enter a waiting state in which the program and/or computer system simply waits for input, whether that input.

Other process flows are contemplated by the present disclosure. For example, management computing system 102 may update the user interface in response to a request from a user of management computing system 102. As another example, management computing system 102 may issue a command in response to a request from a user of management computing system 102.

While the above method has been described primarily with respect to a management computing system 102 managing a single power environment (e.g., power environment 106), as described above, the present disclosure contemplates a management computing system (e.g., management computing system 202) managing multiple microgrids 150/250.

Modifications, additions, or omissions may be made to power administration system 100 without departing from the scope of the disclosure. The components of power administration system 100 may be integrated or separated. For example, management computing system 102 and computer system 138 local to or remote from the elements of power environment 106 that they manage. Moreover, the operations of power administration system 100 may be performed by more, fewer, or other components.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A power administration system, comprising:
a memory module storing power management data for managing a plurality elements of a first power environment, the elements of the first power environment comprising a power system, one or more sensors, and one or more power consumers;
one or more processing modules operable to:
collect operational data for the elements of the first power environment;
translate the collected operational data from a first format to a first abstracted format associated with an abstraction layer for interacting with heterogeneous power environments;
collect external data from one or more external information sources, the one or more external information sources comprising an environmental source operable to provide environmental data;
translate the collected external data from a second format associated with a corresponding external information source to a second abstracted format associated with the abstraction layer for interacting with heterogeneous power environments; and
update the power management data stored in the memory module according to the translated operational data in the first abstracted format and the translated external data in the second abstracted format.

2. The power administration system of claim 1, wherein the one or more processing units are further operable to:
analyze the updated power management data stored in the memory module according to one or more algorithms; and
issue a command to a particular element of the first power environment based on the analysis of the updated power management data.

3. The power administration system of claim 2, wherein:
the command is in a third abstracted format associated with the management system; and
issuing the command comprises communicating the command to a computer system associated with the first power environment, the computer system operable to translate the command to a fourth format understandable to the particular element of the first power environment.

4. The power administration system of claim 2, wherein the command comprises one or more of:
a command to adjust a setting of the particular element of the first power environment;
a command to power on the particular element of the first power environment; and
a command to power off the particular element of the first power environment.

5. The power administration system of claim 1, wherein the one or more processing units are further operable to:
analyze the updated power management data according to one or more algorithms; and
issue, in response to analyzing the updated power management data according to the one or more algorithms, an alert message.

6. The power administration system of claim 1, wherein the power management data for managing the plurality elements of the first power environment comprises one or more of the following:
values for past operational performance of the plurality of elements;
values for current operational performance of the plurality of elements; and
values for predicted future operational performance of the plurality of elements.

7. The power administration system of claim 1, wherein the environmental data comprises one or more of the following:
past weather data;
current weather data; and
forecasted weather data.

8. The power administration system of claim 1, wherein the one or more external information sources further comprise an external economic source operable to provide economic data, the economic data comprising data regarding feed-in-tariffs.

9. The power administration system of claim 1, wherein the one or more processing modules are further operable to generate a graphical user interface for use in managing the first power environment, the generated graphical user interface comprising a visualization of the first power environment suitable for managing the first power environment.

10. The power administration system of claim 9, wherein the one or more processing units are further operable to:
analyze the updated power management data stored in the memory module according to one or more algorithms; and
update, based on the analysis of the updated power management data, the generated graphical user interface for managing the first power environment.

11. The power administration system of claim 1, wherein:
the memory module stores the power management data for managing the first power environment in a plurality of software objects, each software object representing an element of the first power environment; and
the one or more processing modules are operable to update the power management data stored in the memory module by updating one or more appropriate software objects.

12. Software for power administration, the software embodied on non-transitory computer-readable media and when executed using one or more processing units operable to perform operations comprising:
collecting operational data for a plurality of elements of a first power environment, the elements of the first power environment comprising a power system, one or more sensors, and one or more power consumers;
translating the collected operational data from a first format to a first abstracted format associated with an abstraction layer for interacting with heterogeneous power environments;
collecting external data from one or more external information sources, the one or more external information sources comprising an environmental source operable to provide environmental data;
translating the collected external data from a second format associated with a corresponding external information source to a second abstracted format associated with the abstraction layer for interacting with heterogeneous power environments; and
updating stored power management data for managing the plurality elements of a first power environment according to the translated operational data in the first abstracted format and the translated external data in the second abstracted format.

13. The software of claim 12, wherein the software when executed using the one or more processing units is further operable to:
analyze the updated power management data stored in the memory module according to one or more algorithms; and
issue a command to a particular element of the first power environment based on the analysis of the updated power management data.

14. The software of claim 13, wherein:
the command is in a third abstracted format associated with the management system; and
issuing the command comprises communicating the command to a computer system associated with the first power environment, the computer system operable to translate the command to a fourth format understandable to the particular element of the first power environment.

15. The software of claim 13, wherein the command comprises one or more of:
a command to adjust a setting of the particular element of the first power environment;
a command to power on the particular element of the first power environment; and
a command to power off the particular element of the first power environment.

16. The software of claim 12, wherein the software when executed using the one or more processing units is further operable to:
analyze the updated power management data according to one or more algorithms; and
issue, in response to analyzing the updated power management data according to the one or more algorithms, an alert message.

17. The software of claim 12, wherein the power management data for managing the plurality elements of the first power environment comprises one or more of the following:
values for past operational performance of the plurality of elements;
values for current operational performance of the plurality of elements; and
values for predicted future operational performance of the plurality of elements.

18. The software of claim 12, wherein the environmental data comprises one or more of the following:
past weather data;
current weather data; and
forecasted weather data.

19. The software of claim 12, wherein the one or more external information sources further comprise an external economic source operable to provide economic data, the economic data comprising data regarding feed-in-tariffs.

20. The software of claim 12, wherein the software when executed using the one or more processing units is further operable to generate a graphical user interface for use in managing the first power environment, the generated graphical user interface comprising a visualization of the first power environment suitable for managing the first power environment.

21. The software of claim 20, wherein the software when executed using the one or more processing units is further operable to:
analyze the updated power management data stored in the memory module according to one or more algorithms; and
update, based on the analysis of the updated power management data, the generated graphical user interface for managing the first power environment.

22. The software of claim 12, wherein:
the memory module stores the power management data for managing the first power environment in a plurality of software objects, each software object representing an element of the first power environment; and
the software when executed using the one or more processing units is further operable to update the power management data stored in the memory module by updating one or more appropriate software objects.

23. A computer-implemented method for power administration, the method comprising:
collecting, using one or more processing units, operational data for a plurality of elements of a first power environment, the elements of the first power environment comprising a power system, one or more sensors, and one or more power consumers;
translating, using the one or more processing units, the collected operational data from a first format to a first abstracted format associated with an abstraction layer for interacting with heterogeneous power environments;
collecting, using the one or more processing units, external data from one or more external information sources, the one or more external information sources comprising an environmental source operable to provide environmental data;
translating, using the one or more processing units, the collected external data from a second format associated with a corresponding external information source to a second abstracted format associated with the abstraction layer for interacting with heterogeneous power environments; and
updating, using the one or more processing units, stored power management data for managing the plurality elements of a first power environment according to the translated operational data in the first abstracted format and the translated external data in the second abstracted format.
